(19) United States
(12) Patent Application Publication
(10) Pub. No.: US 2026/0350694 A1
(43) Pub. Date: Nov. 5, 2026

(54) SYSTEMS AND METHODS FOR ONLINE BANKING INTERFACE FOR MULTIPLE CHANNELS

(71) Applicant: Wells Fargo Bank, N.A., San Francisco, CA (US)

(72) Inventors: Manish Ashokkumar Adeshara, Fremont, CA (US); Chintan Mehta, San Ramon, CA (US); Ameena Mubeen, Fremont, CA (US); Prabhuswamy M P Patel, Bengaluru (IN); Venkata Praveen Potru, Hyderabad (IN); Amol V. Sapatnekar, San Ramon, CA (US); Pradeep Reddy Vaddireddy, Antioch, CA (US)

(21) Appl. No.: 19/195,033

(22) Filed: Apr. 30, 2025

(51) Int. Cl. G06Q 40/02

(52) U.S. Cl. CPC G06Q 40/02

(57) ABSTRACT

Various examples are directed to computer-implemented systems and methods for providing online banking APIs to serve multiple channels with different user experiences. The method includes receiving a client query specifying desired data context parameters for online banking and retrieving banking data from one or more data sources corresponding to multiple bounded contexts of online banking. The client query is routed to a super graph microservice configured to invoke a plurality of subgraph APIs, each corresponding to a distinct banking domain. Responses from the subgraph APIs are aggregated into a consolidated response comprising only data corresponding to the desired data context parameters specified in the client query, which is then transmitted to a client device. This method minimizes data over-fetching and supports the flexible addition of new subgraph APIs without modification of underlying code, enhancing user experience by delivering precise data tailored to each channel's requirements.

### TECHNICAL FIELD

This document relates generally to computer systems and more particularly to systems and methods for online banking application programming interfaces (APIs) for serving multiple channels with different user experiences.

### BACKGROUND

In the evolving landscape of online banking, customers demand seamless access to financial information across platforms like desktop, mobile, and chat channels. Traditional systems using REST (Representational State Transfer) APIs often lead to inefficiencies, such as over-fetching unnecessary data, resulting in increased processing and bandwidth usage. The need for multiple API endpoints for different contexts complicates system architecture and increases maintenance overhead. As digital banking becomes more complex, there is a pressing need for a flexible system that delivers tailored data efficiently to various channels, reducing network calls and enhancing user experience by providing precise data tailored to each channel's requirements.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates a flowchart for online banking application programming interfaces (APIs);

FIG. 1B illustrates a flowchart for online banking application programming interfaces (APIs) serving multiple channels with different user experiences, according to various embodiments of the present subject matter;

FIG. 1C illustrates a flowchart of a method for online banking APIs serving multiple channels with different user experiences according to various embodiments;

FIG. 2 illustrates an exemplary infrastructure for use in the present subject matter, according to various embodiments;

FIG. 3 illustrates an example machine learning module for online banking APIs, according to various embodiments;

FIG. 4 illustrates a flowchart of a method of training a model for online banking APIs, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

In online banking, customers demand seamless access to financial information across platforms like desktop, mobile, and chat channels. Traditional systems using REST (Representational State Transfer) APIs often lead to inefficiencies, such as over-fetching unnecessary data, resulting in increased processing and bandwidth usage. The need for multiple API endpoints for different contexts complicates system architecture and increases maintenance overhead. As digital banking becomes more complex, there is a pressing need for a flexible system that delivers tailored data efficiently to various channels, reducing network calls and enhancing user experience by providing precise data tailored to each channel's requirements.

The present subject matter provides systems and methods for online banking application programming interfaces (APIs) for serving multiple channels with different user experiences, according to various embodiments. The present systems and methods are demonstrated with financial services data, but may be used for any situation in which multiple input data sources are used or received and assimilated using an API serving multiple channels.

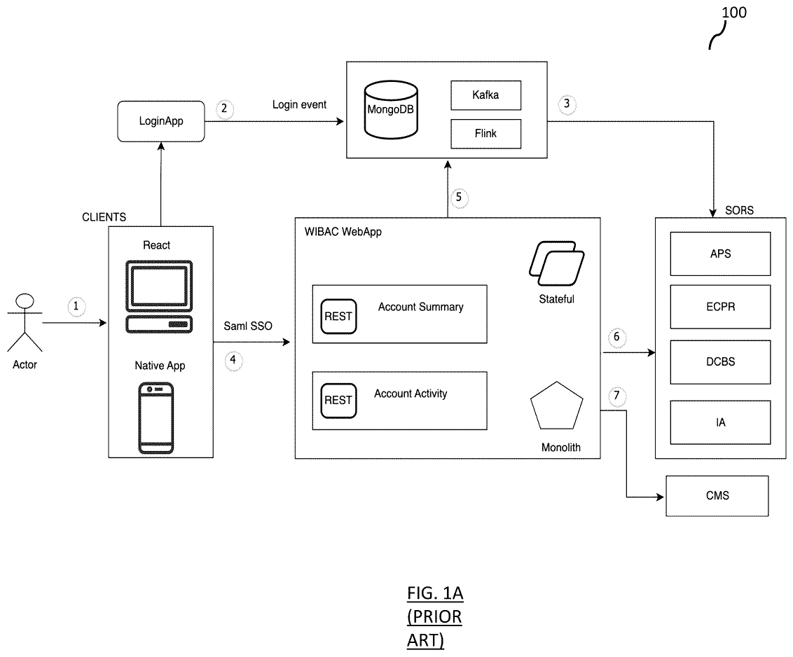

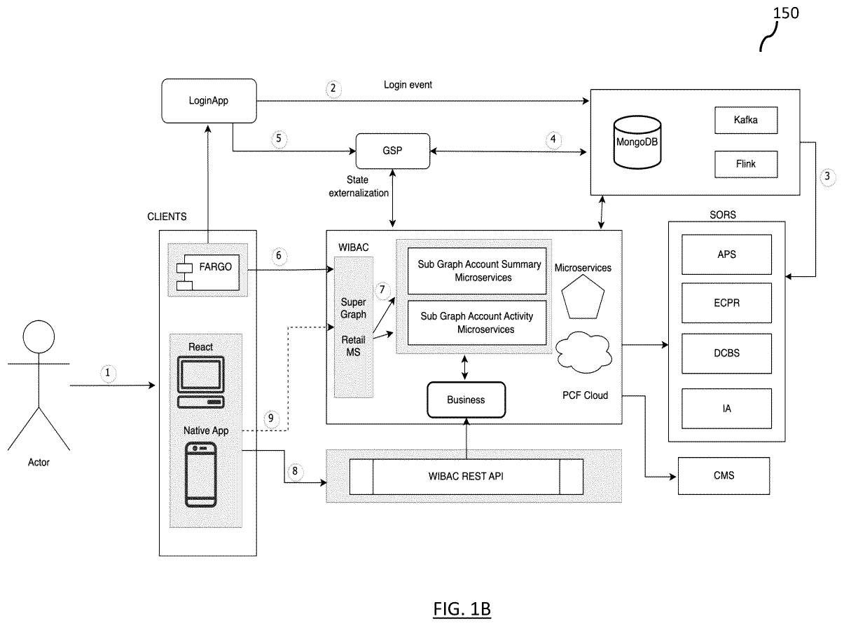

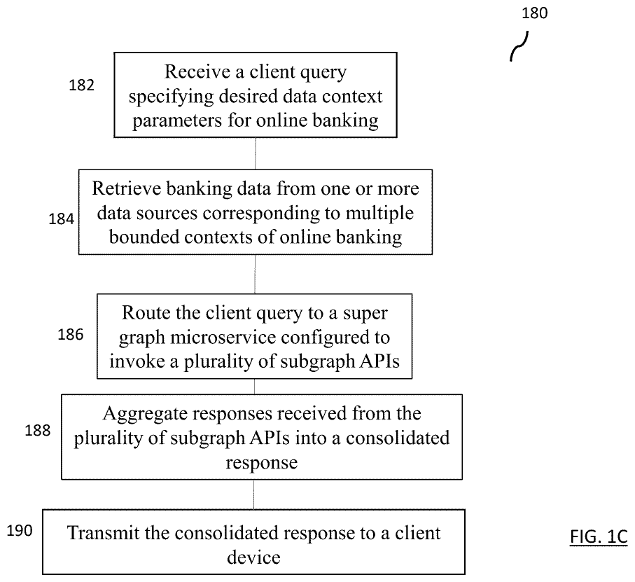

FIG. 1A illustrates a flowchart 100 for online banking application programming interfaces (APIs), representing the previous way of handling online banking data across multiple channels. The process begins when a user logs into the application (step 1). Upon login, the Login App triggers an event, such as a Kafka message, to the Active Data Store Topology (step 2). The topology then connects to various backend systems of record (SORs), fetches the necessary data, and stores it in a database, such as MongoDB, for example (step 3). Subsequently, the client makes a call to the Accounts web application using SAML Single Sign-On (SSO) (step 4). The Accounts application retrieves data from the database and other SORs (steps 6 and 7) to gather information about the user's accounts, devices, offers, content, and other details, ultimately building a complete page response with multiple contexts (step 5).

This prior art system is built as a monolithic application, containing all functional components, including business logic, database operations, and device-agnostic presentation rules. All components are deployed simultaneously and run on the same servers. The introduction of different channels requiring specific context adds additional calls to existing SORs, thereby increasing the load. This approach cannot leverage the current application to serve specific data sets on demand, leading to inefficiencies such as over-fetching data that clients do not require.

FIG. 1B illustrates a flowchart 150 for online banking application programming interfaces (APIs) serving multiple channels with different user experiences, according to various embodiments. The process begins when a user logs into the application (step 1). Upon login, the Login App triggers a Kafka event to the Active Data Store Topology (step 2). The topology connects to various backend systems of record (SORs), fetches the necessary data, and stores it in MongoDB (step 3). The topology then writes the data to the Redis cache, known as the Global State Provider (GSP) (step 4). The Login App validates the GSK token (step 5).

At step 6, the client, such as a chat channel, makes a call to the Retail Banking API, which is a super graph application that connects to the GSP to get the required domain data. The system, comprising a computing system configured to receive a client query specifying desired data context parameters for online banking, processes the client query. The data retrieval module within the computing system retrieves banking data from one or more data sources corresponding to multiple bounded contexts of online banking. The client query is routed to a super graph microservice, which is part of the system, configured to invoke a plurality of subgraph APIs, each corresponding to a distinct banking domain. This super graph microservice supports multiple channels, including desktop, mobile, and chat, using the same API.

At step 7, the Retail Banking microservice routes the request to specific subgraphs (xAPIs) based on the client query. The aggregation module within the computing system aggregates responses received from the plurality of subgraph APIs into a single consolidated response comprising only the data specified in the client query. This process allows for the addition of new subgraph APIs without requiring code modification, enhancing the system's flexibility. The subgraph APIs are built on a tech stack comprising Java and a Domain Graph Service framework, ensuring robust performance.

At step 8, the existing React/native app channel makes a call to the legacy WIBAC API. Finally, at step 9, the transmission module within the computing system transmits the consolidated response to a client device. Security features are integrated into the super graph microservice in compliance with enterprise standards, ensuring that the data transmitted is secure and reliable. The system effectively minimizes data over-fetching and enhances user experience by delivering precise data tailored to each channel's requirements.

FIG. 1C illustrates an example embodiment of a computer-implemented method 180 for online banking application programming interfaces (APIs) to serve multiple channels with different user experiences, according to various embodiments. The process begins at step 182, where a client query specifying desired data context parameters for online banking is received. At step 184, the system retrieves banking data from one or more data sources corresponding to multiple bounded contexts of online banking. At step 186, the client query is routed to a super graph microservice configured to invoke a plurality of subgraph APIs, each subgraph API corresponding to a distinct banking domain. At step 188, the system aggregates responses received from the plurality of subgraph APIs into a consolidated response comprising only data corresponding to the desired data context parameters specified in the client query. Finally, at step 190, the consolidated response is transmitted to a client device.

In step 182, the client query can originate from various channels, including a chat channel requesting specific context data, allowing the system to tailor responses to the specific needs of each channel. Step 184 leverages the GraphQL query language, which provides flexibility in retrieving only the data requested by the client, minimizing over-fetching and enhancing efficiency. At step 186, the super graph microservice supports multiple channels, such as desktop, mobile, and chat, using the same API, which simplifies the architecture and reduces maintenance overhead. Step 188 is designed to facilitate the adding of new subgraph APIs without requiring code modification, thereby enhancing the system's adaptability to evolving requirements. The subgraph APIs, utilized in step 188, are built on a tech stack comprising Java and a Domain Graph Service framework, ensuring robust performance and ease of integration. Finally, the system integrates security features into the super graph microservice in compliance with enterprise standards, ensuring that the data transmitted at step 190 is secure and reliable.

Various embodiments include a computing system with one or more processors and a data storage system in communication with the one or more processors, wherein the data storage system comprises instructions thereon that, when executed by the one or more processors, causes the one or more processors to execute the steps of the method of FIG. 1C. In various examples, the present subject matter uses machine learning. The machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter.

Various embodiments include a non-transitory computer-readable storage medium, the non-transitory computer-readable storage medium including instructions that, when executed by computers, cause the computers to perform operations including the method of FIG. 1C.

The present subject matter introduces a novel approach to online banking APIs by leveraging a super graph microservice architecture, which significantly enhances the flexibility and efficiency of data delivery across multiple channels. Unlike traditional systems that rely on multiple API endpoints, this system allows for a single API to serve various platforms, including desktop, mobile, and chat channels. This unified approach reduces the complexity of system architecture and maintenance overhead, as it eliminates the need for client-specific code and supports the addition of new subgraph APIs without requiring code modification. The use of GraphQL query language further optimizes the system by allowing clients to request only the data they need, thereby minimizing data over-fetching and improving response times.

One of the key benefits of this subject matter is its ability to provide a tailored user experience by delivering precise data specific to each channel's requirements. This is particularly advantageous for new channels, such as chat interfaces, which demand specific context data on demand. The system's architecture supports the seamless integration of new features and fields, ensuring that it can adapt to evolving user needs and technological advancements. Additionally, the integration of enterprise-standard security features into the super graph microservice ensures that data transmission is secure and reliable, enhancing user trust and satisfaction. Overall, this subject matter represents a significant technological advancement in the field of online banking, offering a scalable, efficient, and secure solution for delivering financial data across multiple user interfaces.

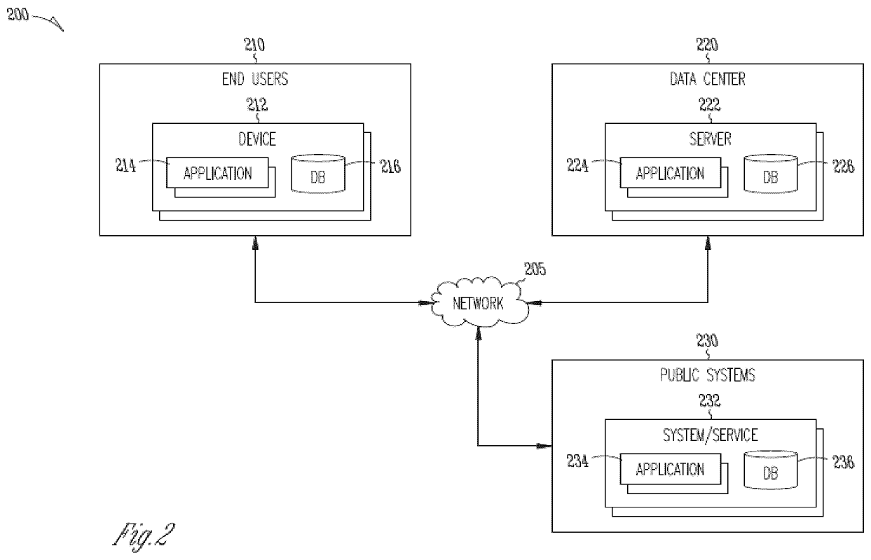

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 800 as described below. The end-user computing devices 212 may comprise applications 214 that are either designed to execute in a stand-alone manner, or interact with other applications 214 located on the device 212 or accessible via the network 205. These devices 212 may also comprise a database 216 that holds data locally, the data being potentially accessible by the local applications 214 or by remote applications.

The system 200 may also include one or more data centers 220. A data center 220 may be a server 222 or the like associated with a business entity that an end user 210 may interact with. The server 222 or other portions of the distributed system may create and manage the system for a home lending data control product, such as by performing operations including the method of FIG. 1C, in various embodiments. The business entity may be a computer service provider, as may be the case for a cloud services provider, or it may be a consumer product or service provider, such as a financial institution. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 800.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 800.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

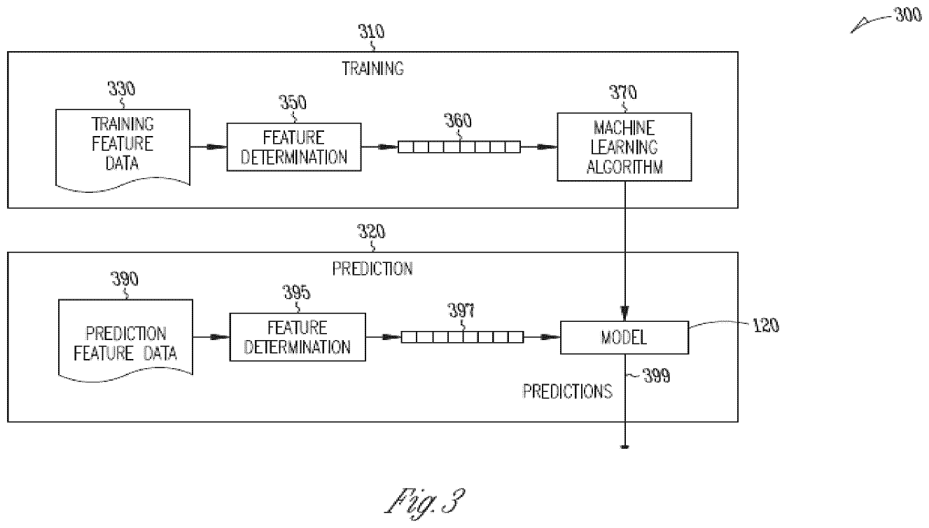

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine. In various examples, the machine learning module 300 may be used for one or more of routing the client query or aggregating responses. In various examples, the machine learning module 300 may be generally for a client API management.

Machine learning module 300 utilizes a training module 310 and a prediction module 320. Training module 310 inputs training feature data 330 into feature determination module 350. The training feature data 330 may include data determined to be predictive of one or more of routing the client query or aggregating responses. Categories of training feature data may include financial data, user portfolio data, tracked user data, input user data, news articles, social media data, other third-party data, or the like. Specific training feature data and prediction feature data 390 may include, for example one or more of: current tracked user data, past tracked user data, and the like.

Feature determination module 350 selects training vector 360 from the training feature data 330. The selected data may fill training vector 360 and comprises a set of the training feature data that is determined to be predictive of a data ingestion configuration framework. In some examples, the tasks performed by the feature determination module 350 may be performed by the machine learning algorithm 370 as part of the learning process. Feature determination module 350 may remove one or more features that are not predictive of the data ingestion configuration framework to train the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as a data ingestion. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

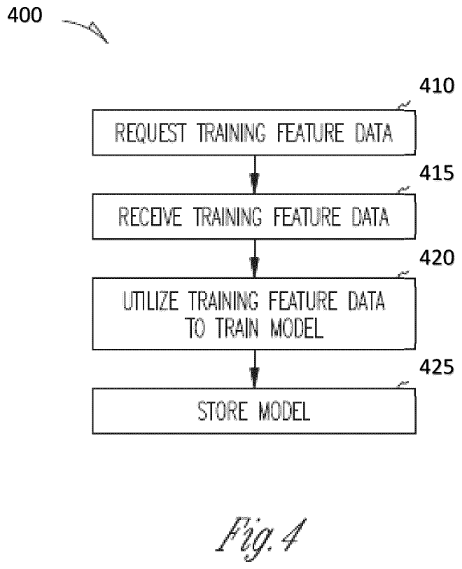

FIG. 4 illustrates a flowchart of a method 400 of training a model for online banking application APIs, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions. In various examples, the model may be used for one or more of routing the client query or aggregating responses. In various examples, the model may be generally for online banking application programming interfaces (APIs).

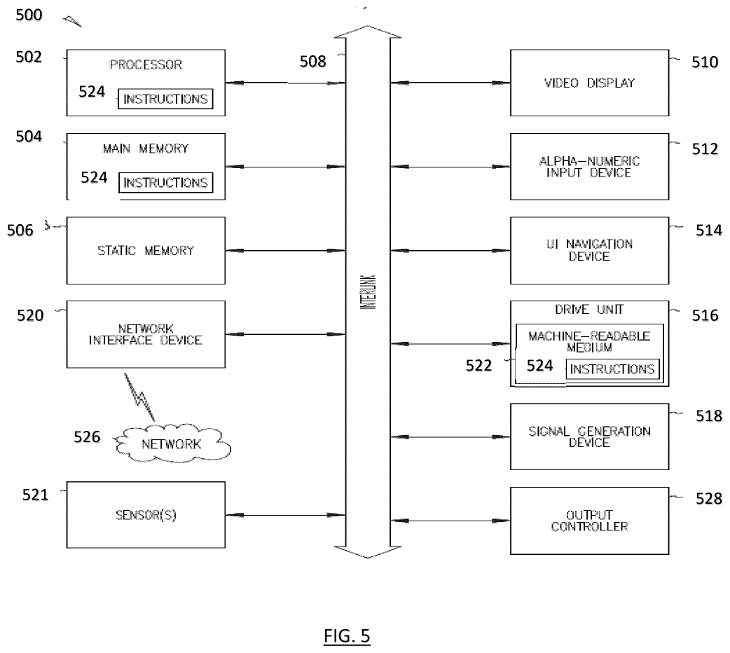

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1B, 1C and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a computer-implemented method including receiving, by a computer system, a client query specifying desired data context parameters for online banking, retrieving, by the computer system, banking data from one or more data sources corresponding to multiple bounded contexts of online banking, routing, by the computer system, the client query to a super graph microservice configured to invoke a plurality of subgraph APIs, each subgraph API corresponding to a distinct banking domain, aggregating, by the computer system, responses received from the plurality of subgraph APIs into a consolidated response comprising only data corresponding to the desired data context parameters specified in the client query, and transmitting, by the computer system, the consolidated response to a client device.

In Example 2, the subject matter of Example 1 optionally includes wherein the client query is received from a chat channel requesting specific context data.

In Example 3, the subject matter of Example 1 optionally further includes utilizing a GraphQL query language to provide the client device with the data requested.

In Example 4, the subject matter of Example 1 optionally includes wherein the super graph microservice is capable of supporting multiple channels, including desktop, mobile, and chat.

In Example 5, the subject matter of Example 1 optionally further includes adding new subgraph APIs without code modification.

In Example 6, the subject matter of Example 1 optionally includes wherein the plurality of subgraph APIs are built on a tech stack comprising Java and a Domain Graph Service framework.

In Example 7, the subject matter of Example 1 optionally further includes integrating security features into the super graph microservice in compliance with enterprise standards.

Example 8 is a system including a computing system comprising one or more processors and a data storage system in communication with the one or more processors, wherein the data storage system comprises instructions thereon that, when executed by the one or more processors, causes the one or more processors to: receive a client query specifying desired data context parameters for online banking, retrieve banking data from one or more data sources corresponding to multiple bounded contexts of online banking, route the client query to a super graph microservice configured to invoke a plurality of subgraph APIs, each subgraph API corresponding to a distinct banking domain, aggregate responses received from the plurality of subgraph APIs into a consolidated response comprising only data corresponding to the desired data context parameters specified in the client query, and transmit the consolidated response to a client device.

In Example 9, the subject matter of Example 8 optionally includes wherein the client query is received from a chat channel requesting specific context data.

In Example 10, the subject matter of Example 8 optionally further includes a GraphQL query language module configured to provide the client device with the data requested.

In Example 11, the subject matter of Example 8 optionally includes wherein the super graph microservice is capable of supporting multiple channels, including desktop, mobile, and chat.

In Example 12, the subject matter of Example 8 optionally further includes a module for adding new subgraph APIs without code modification.

In Example 13, the subject matter of Example 8 optionally includes wherein one or more of routing the client query or aggregating responses includes using machine learning.

In Example 14, the subject matter of Example 13 optionally includes wherein using machine learning includes using a machine learning model including one or more of a neural network, a long short-term memory (LSTM) network, bidirectional encoder representations from transformers (BERT), natural language processing (NLP), or an artificial intelligence (AI)-based knowledge tree.

Example 15 is a non-transitory computer-readable storage medium, the non-transitory computer-readable storage medium including instructions that, when executed by computers, cause the computers to perform operations of: receiving a client query specifying desired data context parameters for online banking, retrieving banking data from one or more data sources corresponding to multiple bounded contexts of online banking, routing the client query to a super graph microservice configured to invoke a plurality of subgraph APIs, each subgraph API corresponding to a distinct banking domain, aggregating responses received from the plurality of subgraph APIs into a consolidated response comprising only data corresponding to the desired data context parameters specified in the client query, and transmitting the consolidated response to a client device.

In Example 16, the subject matter of Example 15 optionally includes wherein the client query is received from a chat channel requesting specific context data.

In Example 17, the subject matter of Example 15 optionally further includes utilizing a GraphQL query language to provide the client device with the data requested.

In Example 18, the subject matter of Example 15 optionally includes wherein the super graph microservice is capable of supporting multiple channels, including desktop, mobile, and chat.

In Example 19, the subject matter of Example 15 optionally further includes adding new subgraph APIs without code modification.

In Example 20, the subject matter of Example 15 optionally includes wherein the plurality of subgraph APIs are built on a tech stack comprising Java and a Domain Graph Service framework.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A computer-implemented method, comprising:
receiving, by a computer system, a client query specifying desired data context parameters for online banking;
retrieving, by the computer system, banking data from one or more data sources corresponding to multiple bounded contexts of online banking;
routing, by the computer system, the client query to a super graph microservice configured to invoke a plurality of subgraph APIs, each subgraph API corresponding to a distinct banking domain;
aggregating, by the computer system, responses received from the plurality of subgraph APIs into a consolidated response comprising only data corresponding to the desired data context parameters specified in the client query; and
transmitting, by the computer system, the consolidated response to a client device.

2. The method of claim 1, wherein the client query is received from a chat channel requesting specific context data.

3. The method of claim 1, further comprising utilizing a GraphQL query language to provide the client device with the data requested.

4. The method of claim 1, wherein the super graph microservice is capable of supporting multiple channels, including desktop, mobile, and chat.

5. The method of claim 1, further comprising adding new subgraph APIs without code modification.

6. The method of claim 1, wherein the plurality of subgraph APIs are built on a tech stack comprising Java and a Domain Graph Service framework.

7. The method of claim 1, further comprising integrating security features into the super graph microservice in compliance with enterprise standards.

8. A system comprising:
a computing system comprising one or more processors and a data storage system in communication with the one or more processors, wherein the data storage system comprises instructions thereon that, when executed by the one or more processors, causes the one or more processors to:
receive a client query specifying desired data context parameters for online banking;
retrieve banking data from one or more data sources corresponding to multiple bounded contexts of online banking;
route the client query to a super graph microservice configured to invoke a plurality of subgraph APIs, each subgraph API corresponding to a distinct banking domain;
aggregate responses received from the plurality of subgraph APIs into a consolidated response comprising only data corresponding to the desired data context parameters specified in the client query; and
transmit the consolidated response to a client device.

9. The system of claim 8, wherein the client query is received from a chat channel requesting specific context data.

10. The system of claim 8, further comprising a GraphQL query language module configured to provide the client device with the data requested.

11. The system of claim 8, wherein the super graph microservice is capable of supporting multiple channels, including desktop, mobile, and chat.

12. The system of claim 8, further comprising a module for adding new subgraph APIs without code modification.

13. The system of claim 8, wherein one or more of routing the client query or aggregating responses includes using machine learning.

14. The system of claim 13, wherein using machine learning includes using a machine learning model including one or more of a neural network, a long short-term memory (LSTM) network, bidirectional encoder representations from transformers (BERT), natural language processing (NLP), or an artificial intelligence (AI)-based knowledge tree.

15. A non-transitory computer-readable storage medium, the non-transitory computer-readable storage medium including instructions that, when executed by computers, cause the computers to perform operations of:
receiving a client query specifying desired data context parameters for online banking;
retrieving banking data from one or more data sources corresponding to multiple bounded contexts of online banking;
routing the client query to a super graph microservice configured to invoke a plurality of subgraph APIs, each subgraph API corresponding to a distinct banking domain;
aggregating responses received from the plurality of subgraph APIs into a consolidated response comprising only data corresponding to the desired data context parameters specified in the client query; and
transmitting the consolidated response to a client device.

16. The non-transitory computer-readable storage medium of claim 15, wherein the client query is received from a chat channel requesting specific context data.

17. The non-transitory computer-readable storage medium of claim 15, further comprising utilizing a GraphQL query language to provide the client device with the data requested.

18. The non-transitory computer-readable storage medium of claim 15, wherein the super graph microservice is capable of supporting multiple channels, including desktop, mobile, and chat.

19. The non-transitory computer-readable storage medium of claim 15, further comprising adding new subgraph APIs without code modification.

20. The non-transitory computer-readable storage medium of claim 15, wherein the plurality of subgraph APIs are built on a tech stack comprising Java and a Domain Graph Service framework.
